(19) United States
(12) Patent Application Publication
(10) Pub. No.: US 2002/0148552 A1
(43) Pub. Date: Oct. 17, 2002

(54) Method of forming articles with a dimpled surface resembling a golf ball

(75) Inventors: Walter Brian Finley, Dunwoody, GA (US); Richard Paul Beach, Suwanee, GA (US)

Correspondence Address: Jason A. Bernstein, BERNSTEIN & ASSOCIATES, P.C., 6600 Peachtree Dunwoody Road, N.E., Embassy Row 400, Suite 495, Atlanta, GA, 30328-1649, US

(73) Assignee: GRW Promotions, Inc.

(21) Appl. No.: 09/964,047

(22) Filed: Sep. 26, 2001

Related U.S. Application Data
(60) Provisional application No. 60/284,240, filed on Apr. 17, 2001.

(51) Int. Cl. B31F 1/00; B32B 31/00

(52) U.S. Cl. 156/196; 156/219; 156/256; 156/277

(57) ABSTRACT

A method of forming an article having at least a portion of its surface resembling a dimpled golf ball comprising forming dimples in a sheet of polymer or paper material by debossing or other means, cutting or otherwise forming the debossed material into a pattern, and affixing the pattern to an article.

### CROSS-REFERENCE TO RELATED APPLICATION

This application claims the priority benefit of copending U.S. Provisional Application No. 60/284,240, filed Apr. 17, 2001, which is hereby incorporated by reference in its entirety.

### FIELD O F THE INVENTION

The present invention relates generally to a method of forming articles having at least a part of their surface resembling the texture of a conventional golf ball.

### BACKGROUND OF THE INVENTION

Over the years the sport of golf has enjoyed continuous growth and popularity. From the standpoint of professionals, fans, sporting goods manufacturers and corporate sponsors, the market for golf related items continues to expand with a eye toward new and unique products. Additionally, consumers are always looking for functional devices with a golf related feature.

The standard round golf ball, with its history of use and evolution has maintained the dimpled pattern exterior making it readily identifiable with the golf industry. Over the years, the golf ball dimpled pattern has been modified due to technology advancements and performance issues. It should be noted that injection molding is used to create a one-piece construction and has been the single means by which golf balls are manufactured. There are over 1,500 golf ball related patents, all of which address golf ball dimple patterns, cover composition, spherical surfaces, etc. However, none deal with a flat golf ball and flat dimpled cover material. There is no art or process to create golf balls or golf ball material in a flat sheet form, nor have any items been designed using flat golf ball cover material.

Currently corporate sponsors struggle to find new and exciting objects to advertise and promote golf outings and brand recognition both on and off the golf course. Many golf promotional products and items have short life expectancies due to their being considered disposable and often find their way being discarded. Manufacturers also seek ways to keep their name and brand in front of the public. Greater brand recognition translates into more opportunities for increased sales.

An additional problem with current golf related novelty items is that they are not durable and can be easily damaged or ruined.

A common problem with memorabilia and autograph collectors is the very limited selection of golf related products that can be collected and/or autographed by sports and celebrity figures. Many celebrities or sports personalities refuse or are unable to sign or autograph a golf ball since it is too small and difficult to write upon. Handling such a small item also leads to damaged autographs due to smudging or wear. Physically carrying larger golf memorabilia items can prove to be too expensive, bulky or cumbersome.

Therefore, the inventors herein have determined that there is a need and market for a flat golf ball material with the look, feel and durability of a standard golf ball that has been flattened. Said material will be used for the manufacture of golf related items or products and fill the current void that exists.

### SUMMARY OF THE INVENTION

Generally described, the present invention provides a flat golf ball and flat golf ball cover material using polyvinyl or similar type plastic material. The plastic material will be used in the debossing manufacturing process to create a flat dimpled golf ball cover material that can then be used to make products covered by or constructed from the flat dimpled golf ball material, such as a 4″ flat golf ball coaster, cup holder, golf bag, lamp shade, loose leaf binder, waste basket, utility bag, back pack, hand bag, desk set, chair, cell phone cover, address book, photo album, plaque, rectangular place mat, check book cover, cap, beach ball, or the like.

The present invention also provides a method of manufacturing an article having at least a portion of its surface being dimpled and having the appearance resembling that of a golf ball.

In a preferred embodiment the method comprises providing a generally flat sheet of material; forming a dimpled surface on said sheet of material; forming a shine to the surface of said sheet of material; cutting said material into a pattern; and, affixing said pattern to a surface.

These and other features, and advantages of the present invention are discussed or apparent in the following detailed description of the invention, in conjunction with the appended claims.

### BRIEF DESCRIPTION OF THE DRAWINGS

The invention is illustrated in the drawings in which like reference characters designate the same or similar parts throughout the figures of which:

FIG. 1 is a perspective view of a coaster article formed by the method of the preferred embodiment of the present invention.

FIG. 2 is a top view of a coaster article formed by the method of the preferred embodiment of the present invention.

### DETAILED DESCRIPTION OF THE PREFERRED EMBODIMENTS

In general, the present invention provides a method of forming an article having at least a portion of its surface being dimpled so as to resemble the dimpled surface of a conventional golf ball. In a first preferred embodiment, the method comprises providing a sheet of material. The material is preferably flat, but can be of other regular or irregular geometry or texture. The material is preferably made of a polymeric material, such as, but not limited to, vinyl, acrylic, styrene, Sintra, plastic, polyurethane, PVC or other synthetic compound, and the like. The material can be of any suitable thickness. Preferably, the material is between about 8 and about 20 mils. Alternatively, the material can be a paper material coated with or laminated to a clear, translucent or opaque plastic component, such as, but not limited to, polypropylene film, UV clear ink coating, and the like. Such plastic component can impart a shine to the paper material. In a preferred embodiment the paper material is about 15 points thick, although any suitable thickness can be used. Thickness can be determined by the specific usage requirements and desired visual appearance as well as the article to which the material will be associated.

A pattern is then imprinted on the material. Imprinting can be done by any conventional means. In a preferred embodiment a debossing roller or die is used. Such roller or die is formed with a series of semispherical, other shaped protrusions, regular patterns (such as, but not limited to, lines, grids, or the like), irregular patterns or textures on the roller or die surface. For the purposes of the present disclosure, the term “dimples” will be used and is intended to include other shapes or forms imprintable on the material. When contacted with the polymeric or paper material under pressure, the protrusions form dimples in the material. In the case of a roller, the material can be passed between a pair of nip rolls, where one of the rolls contains the protrusions and the other roll is an anvil roll. For certain applications where double sided debossing is desired, the nip rolls can both have protrusions so as to imprint on both sides of the material. Alternatively, two sets of nip rolls can be used, each set having a debossing roll and an anvil roll configured to print one side and then the other side of the material. Such apparatus are known to those skilled in the art.

In a preferred embodiment, the dimples have a diameter size range of about 1/16 inch to about 3/16 inch. In a more preferred embodiment, the dimples are uniformly about ⅛ inch in diameter and are evenly spaced across the material. It is to be understood that unevenly spaced dimples can be created by changing the spacing of the protrusions on the debossing surface.

Alternatively, the dimpled polymer material can be formed as follows. A polymer resin can be extruded into a sheet and passed through a pair of nip rolls (or other debossing means, as described hereinabove) to form the dimples during the sheet formation process.

In a preferred embodiment, the dimpled material is optionally coated with a clear coating to provide a shine to the surface. The dimple material can optionally be coated with a UV protective coating to retard material aging. It is also possible for the surface shine to be formed during the material formation (e.g., extrusion) process or, after material formation, but before debossing.

After the material formation process and any post-treatment steps are complete, the material is cut to form a pattern. The pattern or shape will depend on the use of the material or the structure to which the pattern or shape will be associated. For particular uses, the material sheet can be sliced into lengths of narrower material.

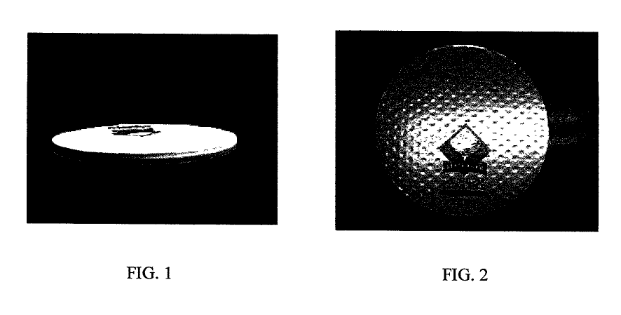

After the material is cut or otherwise formed into the desired pattern or shape, it can be considered a finished product, or, it can be affixed, permanently or temporarily, to a surface or object. By way of illustration, but not limitation, examples of articles to which the pattern can be affixed include, a coaster (shown in FIGS. 1 and 2), cup holder, golf bag, lamp shade, loose leaf binder, waste basket, utility bag, back pack, hand bag, desk set, chair, cell phone cover, address book, photo album, plaque, rectangular place mat, check book cover, cap, beach ball, or the like.

The material can be affixed by any means known to those skilled in the art. Illustrative of such affixation means are laminating, stitching, gluing, heat sealing, fusing, using a fastener (for example, grommets, hook and loop fasteners, rivets, buttons, snaps, hooks, clatches, and the like), sonic welding, or combinations of the foregoing.

It is also possible for the formed material to be affixed to a backing material. This material can then be affixed to an article or used as is.

In a second preferred embodiment the polymer material (as described hereinabove) can be laminated to a layer of paper material. Alternatively, multiple layers of polymer and/or paper can be laminated together to form a single sheet of material. Such laminate can then be debossed with the dimples. Either of the two types of layers can be imprinted with indicia or debossed prior to lamination.

The articles of the present invention will be durable and have a long lasting finish thereby creating a uniquely durable item that resists water, damage, or discoloration.

Additionally the item can be used for affixing or imprinting advertising, trademarks and other writings or symbols that will promote a corporate sponsor, event or charity, as it relates to a golf venue or appeals to a golf enthusiast.

Collectors, sports personalities and celebrities will also benefit from the ability to sign, autograph and collect memorabilia related to golf and golf products. The ability to sign an item that is not small and round, like a standard golf ball, will be a benefit to the signer. The signer will not have to struggle writing on a small round surface. The collector will be able to collect many unique items or acquire several signatures on the same item due to the reasonable size and weight of the piece. (i.e., 4 inch flat golf ball coaster covered with flat golf ball material, etc.)

It will be understood that the methods steps of the invention can be carried out in various sequences, and the sequences describe herein are provided as an illustration only and by no means as a limitation in any sense.

It will be understood that the terms “a” and “an” as used herein are not intended to mean only “one,” but may also mean a number greater than “one.”

While the invention has been described in connection with certain preferred embodiments, it is not intended to limit the scope of the invention to the particular forms set forth, but, on the contrary, it is intended to cover such alternatives, modifications, and equivalents as may be included within the true spirit and scope of the invention as defined by the appended claims. All patents, applications and publications referred to herein are hereby incorporated by reference in their entirety.

Claimed is:

1. A method of forming an article, comprising:
a) providing a generally flat sheet of material;
b) forming a dimpled surface on said sheet of material;
c) cutting said material into a pattern; and,
d) affixing said pattern to a surface.

2. The method of claim 1, wherein said sheet of material is formed from a polymer.

3. The method of claim 1, wherein said sheet of material is formed from a multi-layer material.

4. The method of claim 3, wherein said multi-layer material comprises at least one layer of paper and at least one layer of plastic.

5. The method of claim 1, further comprising the step of coating said formed material with a protective material.

6. The method of claim 5, wherein said protective material is an ultraviolet light protective material.

7. The method of claim 1, wherein said dimples are formed by imprinting a pattern on said sheet of material using means for debossing a pattern.

8. The method of claim 1, wherein said affixing is achieved by laminating, stitching, gluing, heat sealing, fusing or by using a fastener.

9. The method of claim 1, wherein said surface is substantially planar.

10. The method of claim 1, wherein said surface is substantially cylindrical.

11. The method of claim 1, further comprising printing indicia on said sheet of material.

12. The method of claim 1, further comprising forming a shine to the surface of said sheet of material.

13. An article formed by a method, comprising:
a) providing a generally flat sheet of a polymer material;
b) forming a dimpled surface on said sheet of polymer material;
c) cutting said dimpled polymer material into a pattern; and, d) affixing said pattern to a surface.

14. A method of forming an article, comprising:
a) providing a layer of paper material;
b) printing indicia on said paper layer;
c) providing a layer of a substantially clear material;
d) laminating said printed paper layer to said clear layer to form a laminate material;
e) forming a dimpled surface on said laminate.
f) mounting said dimpled laminate to a rigid backing surface;
g) cutting said mounted laminate to form a pattern.

15. The method of claim 14, further comprising coating said laminate material with a protective material.

16. The method of claim 15, wherein said protective material is a ultraviolet light protective coating.
